(19) United States
(12) Patent Application Publication
(10) Pub. No.: US 2025/0379460 A1
(43) Pub. Date: Dec. 11, 2025

(54) POWER DOLLY

(71) Applicant: ROBE lighting s.r.o., Roznov pod Radhostem (CZ)

(72) Inventors: Jonny Milmer, Northampton (GB); Martin Sedlar, Loucka u Valasskeho Mezirici (CZ); Jindrich Vavrik, Zubri (CZ); Josef Valchar, Prostredni Becva (CZ)

(21) Appl. No.: 19/307,944

(22) Filed: Aug. 22, 2025

(30) Foreign Application Priority Data
Aug. 28, 2024 (GB) 2412597.3

(51) Int. Cl. H02J 7/00; B62B 3/12; H01M 10/46; H01M 10/48; H01M 50/247

(52) U.S. Cl. CPC H02J 7/0042; B62B 3/12; H01M 10/46; H01M 10/488; H01M 50/247; H02J 7/00032; H01M 2220/30

(57) ABSTRACT

A power dolly includes a planar platform supported by at least three wheels, a battery mechanically coupled to the planar platform and located between the wheels, a mains input connector configured to receive mains power and to charge the battery, a battery charger electrically coupled to the mains input connector and configured to charge the battery using mains power received at the mains input connector, an inverter configured to receive direct current (DC) power from the battery and to provide alternating current (AC) power at an inverter output connector, and a wireless communication receiver configured to receive a control signal and to output the received control signal via a control output connector.

### CROSS-REFERENCE TO RELATED APPLICATIONS

This application claims priority to United Kingdom Patent Application No. 2412597.3 filed with the United Kingdom Intellectual Property Office on Aug. 28, 2024, which is incorporated herein by reference in its entirety.

### BACKGROUND

The present disclosure relates generally to a power dolly and finds particular, although not exclusive, utility in the transporting of lighting equipment on stages.

Dollies typically comprise a board on wheels, and are used for moving relatively heavy objects. They are known for transporting items, such as electrical equipment, from one location to another. Once the electrical equipment has been moved to a desired location, the electrical equipment is typically removed from the dolly, and electrical power is provided to the electrical equipment. This typically requires running power cables between a power connector and the electrical equipment. This can place restrictions on where the electrical equipment can be located, and can present trip hazards.

Alternatively, batteries may be used to power the electrical equipment. However, this also requires running power cables between the batteries and the electrical equipment, which can present a trip hazard. Some batteries may be portable and may be moved to a location near to the electrical equipment. However, this requires more space to accommodate both the electrical equipment and the batteries, requires both the batteries and electrical equipment to be moved, and may still present a trip hazard due to power cables running between the batteries and the electrical equipment. These problems are exacerbated on stages, such as theatre production stages, where space is at a premium.

A further disadvantage of the prior art systems described above is that it may be time consuming to move both the electrical equipment and the power source, and it may not be possible to move both of these components without interrupting the power supply to the electrical equipment. For example, the electrical equipment may need to be disconnected from a first power connector and connected to a second power connector. Alternatively, it may be too difficult to move both the electrical equipment and the battery simultaneously, such that these components may need to be disconnected, moved to a different location, and reconnected. It is an aim of the present disclosure to overcome such problems.

### SUMMARY

According to a first aspect of the disclosure, there is provided a power dolly comprising a planar platform supported on at least three wheels for movement of the platform, the power dolly further comprising a battery located between the wheels, the battery configured to provide electrical power to electrical equipment supported on the platform.

In this way, electrical equipment may be placed on top of the platform, thus saving space. Examples of such electrical equipment include video panels, audio amplifiers, directable spotlights, and automated lighting fixtures.

Furthermore, the power dolly according to the disclosure may be moved to different locations while electrical power is supplied to the electrical equipment, thereby improving the portability of the electrical equipment and improving safety by avoiding the need to have power cables running between a power source, such as a power socket, and the electrical equipment. In addition, both the electrical equipment and the battery may be moved simultaneously, easily, and without interrupting the power supply to the electrical equipment.

The power dolly may further comprise one or more attachment points configured to mechanically couple the planar platform to a truss or other structure. As examples, an attachment point may be configured to (i) secure the electrical equipment to the platform, (ii) secure a frame to the platform, where the frame is configured to support the electrical equipment, or (iii) secure the power dolly to a truss, where the power dolly is configured to be supported by the truss. In some embodiments, the attachment points comprise holes, which may be threaded or configured to receive quarter-turn fasteners, and configured to receive fixing means such as bolts, screws, clamps, or other fasteners. Additionally or alternatively, the attachment points may comprise clamps configured to fit around a truss or frame member.

In this way, electrical equipment may be secured to the power dolly (e.g., directly, or via a frame) thereby reducing a risk of the electrical equipment falling off the power dolly, when the power dolly is stationary. Additionally, the attachment points may reduce the risk of the electrical equipment falling off the power dolly when the power dolly is moved between different locations. The attachment points also reduce the risk of the electrical equipment falling off the power dolly due to a user accidentally knocking into the electrical equipment.

A further advantage associated with the one or more attachment points being configured to secure a frame to the platform is that the frame may be held securely by the power dolly, while electrical power is provided from the power dolly to the electrical equipment supported by the frame. A frame is a structure to which electrical equipment, such as stage lighting, may be attached. A frame may be referred to as an accessory mount. The capability of securing a frame to the platform reduces the need for the frame to be secured to a structure or surface other than the platform (e.g., the ground). In addition, the capability of securing a frame to the platform enables electrical equipment, the frame configured to support the electrical equipment, and the battery in the power dolly, to be moved simultaneously and without interruption of the electrical power being supplied to the electrical equipment.

One or more of the attachment points may be configured to secure the power dolly to a truss, for support by the truss. The truss may be used to secure the power dolly and other electrical equipment, such as stage lighting, at an elevated position relative to the stage. The attachment points are configured to allow either or both of securing the power dolly to a truss or securing electrical equipment or a frame to the platform.

By securing the power dolly to a truss, the power dolly may be supported at a location above the stage. Advantageously, this feature enables electrical equipment supported by the truss to be powered by the power dolly, avoiding the need to run power cables from the truss to a power source on the ground, which may involve running power cables along the truss and associated supporting structure. In addition, because the battery is a component of the power dolly, only the power dolly needs to be supported by the truss. In some embodiments, one or more of the attachment points may be located on the same side of the platform as the wheels.

The wheels may be arranged such that they do not protrude beyond the perimeter of the surface of the platform that supports the electrical equipment. In this way, a power dolly according to the disclosure may be located with an edge of the platform abutting another structure, such as a wall, with substantially no gap between the edge of the platform and the structure. Also, this allows two or more dollies to be located with an edge of one platform abutting an edge of the other platform, such that there is substantially no gap between the edges of the platforms. For purposes of this disclosure, the term “substantially no gap” means a gap no greater than that produced by fabrication errors in the platform of the dolly. This feature enables the two or more dollies to support larger electrical equipment by, for example, providing a larger surface area to support the electrical equipment. This feature also provides two or more batteries to be utilised to supply power to electrical equipment.

In one example, four dollies may be arranged together, in a square shape, with a frame arranged in the centre, coupled to one or more attachment points of each dolly and mechanically coupling the four dollies. Such an arrangement may allow a taller frame to be supported, than could be supported by a single dolly, because the four linked dollies provide a greater area of support (or footprint).

The height of the dolly according to the disclosure may be 40% or less of the longer of the width of the dolly and the length of the dolly, the height of the dolly being the dimension of the dolly measured in a perpendicular direction from a planar surface on which the wheels rest, in use, to the planar platform, to support the electrical equipment.

The height of the platform may be in the range 130 mm (millimetres) to 160 mm, and may be 138 mm. In this way, the dolly may have a relatively low centre of gravity, such that the dolly is more stable and less likely to topple over, particularly when the platform of the dolly is used to support electrical equipment, particularly via a frame. This feature may also improve the portability of the dolly when the dolly is not in use (e.g., it may be easier for a user to pick up the dolly when it is not in use, due to the shape of the dolly being more convenient for carrying).

The dolly according to the disclosure may further comprise one or more handles that are configured to carry the dolly by hand. In this way, the dolly may be moved, or transported, between different locations more easily. The dolly may further comprise a wireless DMX512 (512-channel Digital Multiplex) receiver, configured to provide wireless communication with the electrical equipment communicatively coupled to the platform. In this way, the DMX512 receiver may wirelessly receive instructions from a control console or other remote device. In turn, these instructions may be communicated to the electrical equipment communicatively coupled to the platform. Such instructions may be sent from the dolly to the electrical wirelessly and/or by wired communication.

A single cable running between the dolly and the electrical equipment and may be used to provide both power from the battery and a control signal received at the wireless DMX512 receiver to the electrical equipment via separate power and control signal connectors at each end of the cable. Alternatively, a first cable running between the dolly and the electrical equipment may provide power from the battery to the electrical equipment, and a second cable running between the dolly and the electrical equipment may provide a signal received at the wireless DMX512 receiver to the electrical equipment.

The dolly according to the disclosure may further comprise a charging system for charging the battery. The charging system may be a fully-integrated charging system. The battery may be configured to provide electrical power at a selected direct current (DC) voltage via a DC-to-DC converter and/or at a selected alternating current (AC) voltage via an inverter. The dolly may comprise independent control switches to control the DC-to-DC converter and/or the inverter.

The dolly according to the disclosure may be further configured to charge the battery from an external power source and to provide electrical power simultaneously from the external power source to the electrical equipment electrically coupled to the platform, without affecting the charging of the battery. This “loop-through” feature may allow electricity to be supplied to the electrical equipment while the battery is charging, without affecting the charging of the battery.

The above and other characteristics, features and advantages of the present disclosure will become apparent from the following detailed description, taken in conjunction with the accompanying drawings, which illustrate, by way of example, the principles of the disclosure. This description is given for the sake of example only, without limiting the scope of the disclosure. The reference figures quoted below refer to the attached drawings.

In an embodiment a power dolly includes: a planar platform supported by at least three wheels; a battery mechanically coupled to the planar platform and located between the wheels; a mains input connector configured to receive mains power and to charge the battery; a battery charger electrically coupled to the mains input connector and configured to charge the battery using mains power received at the mains input connector; an inverter configured to receive DC power from the battery and to provide AC power at an inverter output connector; and a wireless communication receiver configured to receive a control signal and to output the received control signal via a control output connector.

### BRIEF DESCRIPTION OF THE DRAWINGS

FIG. 1 is a perspective view of a dolly according to the disclosure.

FIG. 2 is a perspective view of the dolly of FIG. 1, including a frame attached thereto.

FIG. 3 is a schematic view of an electrical and control system of the dolly of FIG. 1.

### DETAILED DESCRIPTION

The present disclosure will be described with respect to certain drawings but the disclosure is not limited thereto but only by the claims. The drawings described are only schematic and are non-limiting. Each drawing may not include all of the features of the disclosure and therefore should not necessarily be considered to be an embodiment of the disclosure. In the drawings, the size of some of the elements may be exaggerated and not drawn to scale for illustrative purposes. The dimensions and the relative dimensions do not correspond to actual reductions to practice of the disclosure.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present disclosure. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the disclosure may be combined in any suitable manner with any other particular feature, structure or characteristic of another embodiment or aspect of the disclosure, as would be apparent to one of ordinary skill in the art from this disclosure, in one or more embodiments or aspects.

Similarly, it should be appreciated that in the description various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Moreover, the description of any individual drawing or aspect should not necessarily be considered to be an embodiment of the disclosure. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this disclosure.

Furthermore, while some embodiments described herein include some features included in other embodiments, combinations of features of different embodiments are meant to be within the scope of the disclosure, and form yet further embodiments, as will be understood by those skilled in the art. For example, in the following claims, any of the claimed embodiments can be used in any combination.

In the description provided herein, numerous specific details are set forth. However, it is understood that embodiments of the disclosure may be practised without these specific details. In other instances, well-known methods, structures and techniques have not been shown in detail in order not to obscure an understanding of this description.

In the discussion of the disclosure, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the disclosure will now be described by a detailed description of at least one drawing relating to exemplary features. It is clear that other arrangements can be configured according to the knowledge of persons skilled in the art without departing from the underlying concept or technical teaching, the disclosure being limited only by the terms of the appended claims.

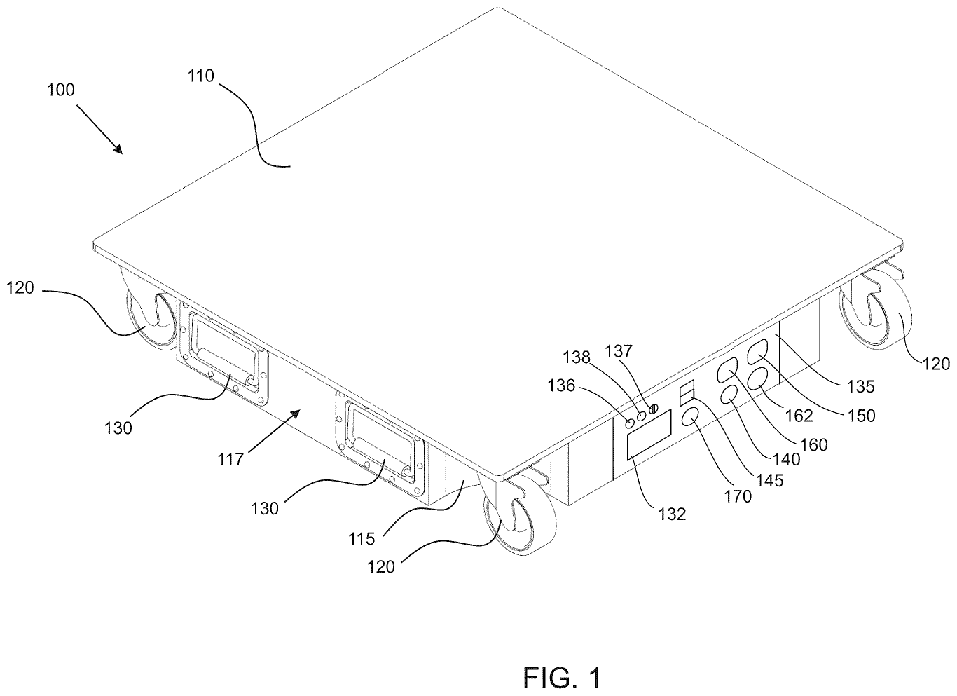

FIG. 1 is a perspective view of a dolly 100 according to the disclosure. The dolly 100 has a planar rectangular platform 110 supported on four caster-like wheels 120, one at each corner, and configured for movement of the platform 110 relative to a surface supporting the wheels 120. In various embodiments, the wheels 120 may be configured as swivel casters and/or fixed-direction wheels. In various embodiments, one or more wheels 120 may be configured with a brake that may be activated by a user of the dolly 100 to prevent rotation of its associated wheel 120. In the embodiment shown in FIG. 1, the platform 110 is supported on four wheels, while in other embodiments the platform of a dolly according to the disclosure may be supported on three wheels or on five or more wheels. In the embodiment shown in FIG. 1, the platform 110 is supported directly by the wheels 120, while in other embodiments the platform 110 may be supported indirectly by wheels 120 attached to a structure that directly supports the platform 110. The platform 110 may have a size in the range of 200 to 1000 mm each side. In one example, the sides each have a length of 750 mm.

A battery compartment 115 is located between the wheels 120 and underneath the platform 110. Its depth is less than the distance between the bottom of the platform 110 and the underside of the wheels 120, such that there is clearance between the underside of the battery compartment 115 and a surface that supports the dolly 100. Two recessed handles 130 are arranged on a first side of the battery compartment 115. Handles (not shown) may additionally or alternatively be arranged on an opposing side of the battery compartment 115 and/or within the top of the platform 110.

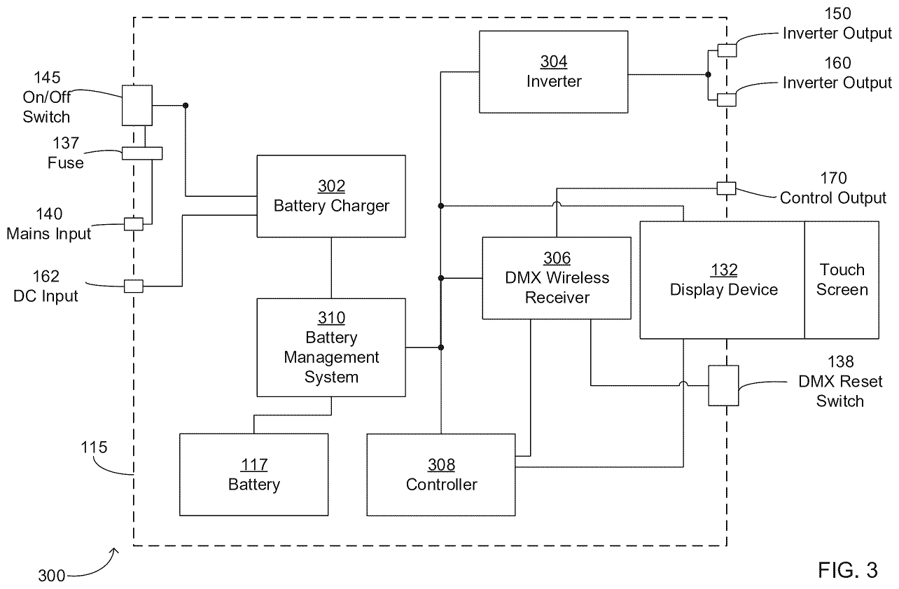

FIG. 3 is a schematic view of an electrical and control system 300 of the dolly 100 of FIG. 1. The electrical and control system 300 is mounted in and on the battery compartment 115. The arrangement of components in the schematic view of FIG. 3 has been changed from the arrangement in FIG. 1 for clarity of presentation in FIG. 3.

Referring now to both FIGS. 1 and 3, on a second side of the battery compartment 115, a control panel 135 is arranged. The control panel 135 includes a mains input connector (or socket) 140, configured to connect the dolly 100 to a mains power supply. “Mains power” may also be referred to as “line power” or “grid power.” AC power from the mains input connector 140 passes through a fuse 137 and an on/off switch 145 before electrically coupling to a battery charger 302. In some embodiments, the on/off switch 145 comprises an integrated pilot light that illuminates when mains power is applied and the on/off switch 145 is in the ‘on’ position. In other embodiments, the on/off switch 145 is coupled to a standalone pilot light mounted in the control panel 135.

The battery charger 302 receives mains power from the on/off switch 145 and is configured to charge a battery 117 that is housed within the battery compartment 115 using the mains power. The battery charger 302 is also configured to charge the battery 117 using DC power received via a DC input connector 162. The battery charger 302 may further be configured to receive such DC power from solar panels, enabling the battery 117 to be charged even when the mains input connector 140 is not coupled to a mains power supply.

An inverter 304 is configured to convert DC power from the battery 117 and provide AC power to the inverter output connectors (or sockets) 150 and 160. In some uses, an external power cable may connect the inverter output connectors 150 and/or 160 to one or more pieces of electrical equipment, such that the electrical equipment receives AC power from the battery 117 of the dolly 100 via the inverter 304. The inverter 304 may selectively provide 120V or 230V power at the inverter output connectors 150 and 160.

The battery 117 is electrically coupled via a battery management system 310 to other elements of the electrical and control system 300. The battery management system 310 is configured to control charging of the battery 117, including preventing over-charging. The battery management system 310 is also configured to control discharging of the battery, for example by the inverter 304, the DMX wireless receiver 306, and/or the controller 308. Such control of discharging may include prevention of over-discharging, for example discharging below a specified charge level. In some embodiments, the battery management system 310 may be an integral element of the battery 117.

The control panel 135 further includes a display device 132 with a touch screen, both communicatively coupled to a controller 308. The touch screen is configured to operate as a user input device. In other embodiments, a different user input device may be provided alternatively or additionally to the touch screen, such as physical buttons. In various embodiments, the controller 308 comprises a microcontroller or other programmable processing system. The controller 308 is configured to receive control signals from the touch screen and/or other input device and to control (i) information displayed on the display device 132, (ii) parameters of components of the electrical and control system 300, and (ii) the output of the inverter 304. In one example, the touch screen is used to select between 120V and 230V output from the inverter 304. In some embodiments, the controller 308 is configured to cause the display device 132 to display a current amount of charge in the battery.

A DMX512 wireless receiver 306 (or other wireless communication receiver) is located on or within the battery compartment 115 and is configured to receive one or more wireless control signals for electrical equipment coupled to the dolly 100. The DMX512 wireless receiver 306 is further configured to output such received control signal(s) to such connected electrical equipment via a control output connector (or socket) 170. A DMX reset switch 138 is configured to cause the DMX512 wireless receiver 306 to reset and restart. Elements of the electrical and control system 300 such as the DMX512 wireless receiver 306, the controller 308, the display device 132 and the touch screen, and the inverter 304 are powered by DC power from the battery 117.

In the embodiment of FIG. 3, the DMX512 wireless receiver 306 is mounted behind the display device 132, where the wireless signals being received may pass through the display device 132 to reach the DMX512 wireless receiver 306. In other embodiments, the DMX512 wireless receiver 306 may be coupled to an antenna mounted on an exterior side of the battery compartment 115 for improved reception of wireless signals.

In some embodiments, the controller 308 is configured to cause the display device 132 to display parameters of the DMX512 wireless receiver 306 on the display device 132. In some such embodiments, the controller 308 is further configured to set parameters of the DMX512 wireless receiver 306 based on control signals received from the touch screen and/or other input device. Such parameters may include a DMX512 universe, a DMX512 channel, and other similar parameters. One or more of the connectors 140, 150, 160, 162, and 170 may comprise standardized power and control connectors used in the stage lighting industry.

In some embodiments, the battery compartment 115 is sealed to meet the Ingress Protection 65 (IP65) rating standard, to reduce damage from dust or moisture. Such embodiments may include a membrane breather valve 136, through which air passes when entering the battery compartment 115. The membrane breather valve 136 is configured to allow air to pass through, while reducing or preventing the passage of water and/or moisture in the form of water droplets. In some such embodiments, air that passes through membrane breather valve 136 further passes over a drying agent, configured to remove water vapor (or humidity) from such incoming air.

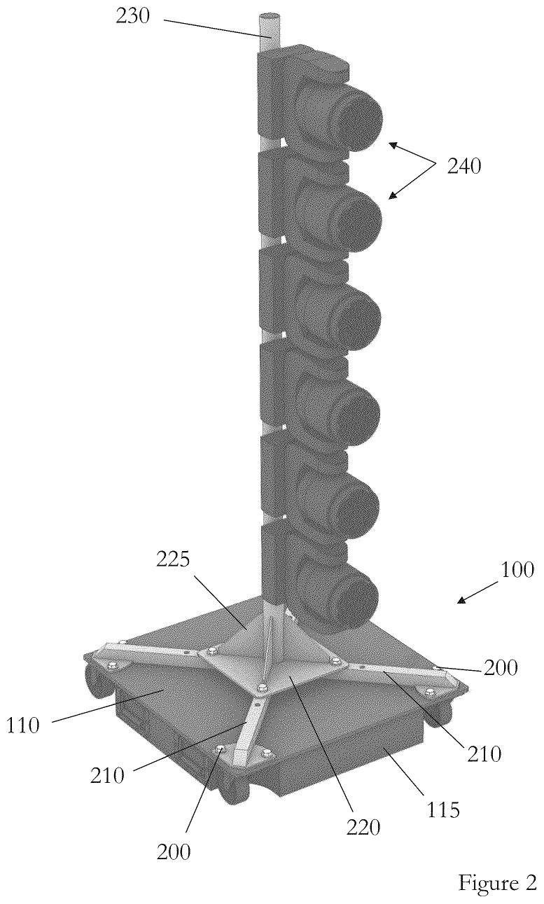

FIG. 2 shows the dolly 100 in perspective with four rectilinear supports 210 attached to the top of the platform 110. The supports 210 extend from each corner into the centre of the platform 110, forming an overall cross shape. The supports 210 are attached to the platform 110 by means of bolts 200 which extend through flanges arranged on either side of the supports 210 at the ends nearest the corners of the platform 110. Corresponding attachment points (not visible in FIG. 2) are arranged within the platform 110 and configured to receive and engage the bolts 200. The bolts may be threaded bolts, quarter-turn fasteners, or other suitable fasteners.

At the centre of the platform 110, where the supports 210 meet, a square plate 220 is arranged. The square plate 220 is bolted to the four supports 210. A rod 230 extends perpendicularly from the plate 220. Gussets 225 extend between the rod 230 and the plate 220 to strengthen the structure.

Six stage lights 240 are attached to the rod 230 in a vertical arrangement. The stage lights 240 may be connected in a daisy-chain fashion to the inverter output connector 160 to receive inverter power and to the control output connector 170 to receive control signals. Accordingly, it may be seen that the dolly 100 is able to movably support, independently power, and provide control signals to the six stage lights 240.

In some embodiments, the attachment points in the platform 110 are configured to mechanically couple a structure (e.g., a frame or a truss) to the top of the platform 110, wherein the structure is supported by the dolly 100. In still other embodiments, the attachment points in the platform 110 are configured to mechanically couple the dolly 100 to a structure, wherein the dolly 100 is supported and may be held off the ground by the structure.

In some embodiments, the battery 117 and the inverter 304 are configured to provide, at the inverter output connector 160, 2000 W (Watt) maximum sustained power delivery at 230V for 3 hours, and 500 W sustained power for 12 hours. In some embodiments, the battery 117 and the inverter 304 are configured to provide 4000 W maximum surge power delivery at 230V. In some embodiments, the dolly is configured to support and move a 550 kg load. In some embodiments, the battery 117 is a plurality of batteries connected in a combination of parallel and/or series connections.

What is claimed is:

1. A power dolly, comprising:
a planar platform supported by at least three wheels;
a battery mechanically coupled to the planar platform and located between the wheels;
a mains input connector configured to receive mains power and to charge the battery;
a battery charger electrically coupled to the mains input connector and configured to charge the battery using mains power received at the mains input connector;
an inverter configured to receive direct current (DC) power from the battery and to provide alternating current (AC) power at an inverter output connector; and
a wireless communication receiver configured to receive a control signal and to output the received control signal via a control output connector.

2. The power dolly of claim 1, further comprising a DC input connector electrically coupled to the battery charger, wherein the battery charger is further configured to charge the battery using DC power received at the DC input connector.

3. The power dolly of claim 1, further comprising an attachment point configured to mechanically couple the planar platform to another structure.

4. The power dolly of claim 3, wherein the attachment point is configured to mechanically couple the power dolly to a structure, wherein the power dolly is supported by the structure.

5. The power dolly of claim 1, wherein the wheels are configured not to protrude beyond a perimeter of the planar platform.

6. The power dolly of claim 5, wherein at least one of the wheels comprises a brake that is configured to be activated by a user of the power dolly to prevent rotation of the wheel.

7. The power dolly of claim 1, wherein a height of the power dolly is 40% or less of a longer of a width of the power dolly and a length of the power dolly, the height of the power dolly being a dimension of the power dolly measured in a perpendicular direction from a bottom of the planar platform to a planar surface on which the wheels rest.

8. The power dolly of claim 1, further comprising one or more handles.

9. The power dolly of claim 1, wherein the wireless communication receiver comprises a wireless 512-channel digital multiplex (DMX512) receiver.

10. The power dolly of claim 1, wherein the inverter is configured to selectively provide 120V or 230V AC power at the inverter output connector.

11. The power dolly of claim 1, further comprising a membrane breather valve configured to allow air to pass through when the air is entering the power dolly.

12. The power dolly of claim 1, wherein the power dolly further comprises a display configured to display a current amount of charge in the battery.

13. The power dolly of claim 12, further comprising a user input device configured to control information displayed on the display.

14. The power dolly of claim 13, wherein the user input device is configured to control parameters of the wireless communication receiver.

15. The power dolly of claim 1, wherein the power dolly is configured to be positioned with an edge of the planar platform abutting another structure.

16. The power dolly of claim 1, wherein the power dolly is a first power dolly and the planar platform is a first planar platform, the first power dolly is configured to be positioned with an edge of the first planar platform abutting a second planar platform of a second power dolly, and one or more attachment points of each of the first power dolly and the second power dolly are configured to mechanically couple the first power dolly to the second power dolly.
